(19) United States
(12) Patent Application Publication
(10) Pub. No.: US 2025/0354846 A1
(43) Pub. Date: Nov. 20, 2025

(54) MODULAR CORIOLIS FLOWMETER

(71) Applicant: Endress+Hauser Flowtec AG, Reinach (CH)

(72) Inventors: Benjamin Schwenter, Ettingen (CH); Peppino Breda, Liestal (CH); Marc Werner, Grenzach-Wyhlen (DE)

(21) Appl. No.: 18/871,437

(22) PCT Filed: May 31, 2023
(86) PCT No.: PCT/EP2023/064517

§ 371 Date: Dec. 3, 2024

(30) Foreign Application Priority Data
Jun. 3, 2022 (DE) 10 2022 114 149.7

(51) Int. Cl. G01F 1/84

(52) U.S. Cl. CPC G01F 1/8413; G01F 1/8427; G01F 1/845

(57) ABSTRACT

A modular Coriolis flowmeter for determining a process variable of a flowable medium includes: a measuring tube module having a measuring tube for guiding the medium; and a support module having a recess in which the measuring tube module can be arranged with a detachable connection, an electronics chamber in which electronics components for operating the flowmeter are arranged, a support module wall bordering the electronics chamber and the recess and having a through-opening connecting the recess to the electronics chamber, and a contactless temperature sensor arranged in the electronics chamber and orientated such that, when the measuring tube module is arranged in the support module, the temperature sensor is directed towards a measuring tube module surface and receives light emitted from the measuring tube module surface through the opening.

The invention relates to a modular Coriolis flowmeter for determining a process variable of a flowable medium.

Process measurement technology field devices with a vibration-type sensor and especially Coriolis flowmeters have been known for many years. The basic structure of such a measuring device is described in, for example, EP 1 807 681 A1, wherein reference is made in full to this publication with respect to the structure of a generic field device within the scope of the present invention.

Typically, Coriolis flow meters have at least one or more vibratable measuring tubes which can be set into vibration by means of a vibration exciter. These vibrations are transmitted along the tube length and are influenced by the type of flowable medium located in the measuring tube and by its flow rate. At another point in the measuring tube, a vibration sensor or, in particular, two vibration sensors spaced apart from one another can record the varied vibrations in the form of a measurement signal or a plurality of measurement signals. An evaluation unit can then determine the mass throughflow, the viscosity, and/or the density of the medium from the measurement signal(s).

The measuring tubes are usually connected to the housing via a distributor piece. In this case, the three components mentioned are welded together. However, Coriolis flowmeters with interchangeable disposable measuring tube arrangements based on a modular design are also known. For example, in WO 2011/099989 A1, a method is thus taught for producing a monolithically formed measuring tube arrangement of a Coriolis flow meter with bent measuring tubes, wherein the measuring tube body of the respective measuring tubes is at first formed as a solid made up of a polymer, and the channel for conducting the flowable medium is subsequently machined into said solid. WO 2011/099989 A1, like U.S. Pat. No. 10,209,113 B2, teaches a connecting body that is configured to receive and support a replaceable measuring tube module comprising thin-walled plastic tubes. The measuring tube module is fastened via the connecting body in a support device equipped with the necessary exciters and sensors.

Coriolis flowmeters are known from the prior art in which the temperature sensor is attached to the measuring tube by, for example, a soldered connection. However, such a solution is extremely disadvantageous for disposable applications, since in this case an electrical contact of the temperature sensor with a measuring circuit must be ensured when arranging the measuring tube module in the recess. In addition, this would mean that the temperature sensor would have to be disposed of after each use of the measuring tube module. Optical temperature sensors are known in principle. US 2017/0102257 A1 discloses the use of an optical temperature sensor in a conventional Coriolis flowmeter. The temperature sensor is located inside the housing and faces the measuring tube. However, such a solution is not suitable for disposable applications in which the measuring tube module is constantly replaced, since when the measuring tube module is inserted into the measuring tube module recess, it may collide with the optical temperature sensor and thus damage both components. Furthermore, the disclosed solution is not cleanable and therefore not suitable for most biopharmaceutical applications.

The object of the invention is to remedy the aforementioned problems.

The object is achieved by the modular Coriolis flowmeter according to claim 1.

The modular Coriolis flowmeter according to the invention for determining a process variable of a flowable medium comprises:
a measuring tube module comprising:
an, in particular metal, measuring tube for guiding the medium;
a primary exciter component arranged on the measuring tube,
a primary sensor component arranged on the measuring tube;
a support module comprising:
   a recess in which the measuring tube module can be arranged with a detachable connection,
   an electronics chamber in which electronics components for operating the modular Coriolis flowmeter are arranged,
   an, in particular metal, support module wall,
      wherein the support module wall borders the electronics chamber and the recess,
      wherein the support module wall has a through-opening which connects the recess to the electronics chamber,
   wherein protective glass is arranged in the opening,
   a contactless temperature sensor which is arranged in the electronics chamber and orientated in such a way that, when the measuring tube module is arranged in the support module, in particular in the recess, the temperature sensor is directed towards a surface of the measuring tube module, in particular a measuring tube surface of the at least one measuring tube, and receives a light beam emitted from the surface of the measuring tube module, in particular the measuring tube surface of the measuring tube, through the opening,
a secondary exciter component that is complementary to the primary exciter component,
   a secondary sensor component that is complementary to the primary sensor component.

By using a contactless temperature sensor, arranging the temperature sensor in the electronics chamber, and separating the electronics chamber and the recess via an opening with protective glass, a solution for temperature measurements is obtained that is suitable for disposable applications and avoids damage when mounting the measuring tube modules.

Advantageous embodiments of the invention are the subject matter of the dependent claims.

One embodiment provides that the temperature sensor is designed as an infrared sensor and the light beam comprises infrared light.

By using an infrared sensor, the temperature of the medium to be guided remains unaffected, and contactless temperature measurements are possible over short distances and in a light-tight space.

One embodiment provides that the protective glass comprises zinc sulfide at least in portions.

One embodiment provides that the protective glass comprises chalcogenides at least in portions.

The two materials mentioned for the protective glass are particularly suitable for the use of infrared sensors, as they are particularly transparent for radiation with a wavelength between 8 and 12 μm.

One embodiment provides that the protective glass has a first diameter d₁ in a first portion and a second diameter d₂ in a second portion,
wherein the first diameter d₁ is larger than the second diameter d₂,
wherein the first diameter d₁ is larger than a smallest diameter d_{oef} of the opening.

One embodiment provides that in the second portion of the protective glass a sealing means, in particular a sealing ring, is arranged on the protective glass, in particular in such a way that it is openly visible from the recess,
wherein the sealing means is adapted to seal the electronics chamber relative to the recess.

The dimensioning of the individual diameters of the protective glass in conjunction with the sealing means results in a solution that is particularly suitable for current Good Manufacturing Practice (cGMP), which allows the support module to be cleaned and to be used in biopharmaceutical applications.

One embodiment provides that the protective glass has an extension d_{L,max} in the longitudinal direction of a maximum of 15 mm, in particular 10 mm and preferably 7 mm, wherein the extension d_{L,min} is at least 0.5 mm, in particular 1 mm and preferably 3 mm.

One embodiment provides that the support module comprises a fastening device for fixing the protective glass in the opening,
wherein the fastening device presses the protective glass from the interior of the electronics chamber towards the recess.

In this case, the fastening device can be designed in such a way that it presses against the protective glass itself or against a sealing means which is arranged between the fastening device and the protective glass.

One embodiment provides that the temperature sensor has an, in particular anodized, aperture for blocking out interference radiation,
wherein the aperture has a minimum distance d_{aperture,min} to the measuring tube surface of 1 mm, in particular 2 mm and preferably 4 mm,
wherein the aperture has a maximum distance d_{aperture,max} to the measuring tube surface of 18 mm, in particular 12 mm and preferably 9 mm.

One embodiment provides that the at least one measuring tube has a temperature measuring point, in particular in the form of a matting, which has a structuring that differs from the rest of the measuring tube surface,
wherein the temperature sensor is directed towards the temperature measuring point.

One embodiment provides that the temperature measuring point is structured by means of a laser process.

One embodiment provides that the temperature measuring point is structured by means of a surface treatment through the action of blasting media, in particular sand.

One embodiment provides that the temperature measuring point is formed by a film applied to the measuring tube, in particular with structurings.

One embodiment provides that the recess is closed in an essentially light-tight manner when the measuring tube module is arranged.

The measuring tube surface and its structure have a significant influence on the emissivity of the measuring tube. The advantage of the above-mentioned embodiments is a standardization of the measuring tube surface or temperature measuring point to be monitored, in order to thus make the results of different measuring tube modules comparable.

One embodiment provides that a distance d_{protection} between the measuring tube surface and the protective glass is less than 5 and greater than 0.5 mm, in particular less than 3 and greater than 0.7 mm and preferably less than 2 and greater than 1 mm. The advantage of the embodiment is that in the mentioned region the at least one measuring tube of the measuring tube module can vibrate freely and at the same the potential interference radiation penetrating the aperture is minimized. At the same time, there is an optimal light beam intensity for temperature measurement.

One embodiment provides that the measuring tube module has a temperature measuring point which is designed as a component attached to the at least one measuring tube, in particular in a form-fitting, force-fitting and/or integral manner,
wherein the temperature sensor is directed at the temperature measuring point, in particular at the component,
wherein the surface lies at least partially on the component.

The advantage of the embodiment is that, due to the component additionally arranged on the measuring tube, the surface area of the measuring tube module, via which the temperature sensor determines the temperature of the medium, is not limited by the nominal diameter of the at least one measuring tube and can therefore be individually adjusted. This is particularly advantageous for measuring tubes with small nominal diameters.

The component can, for example, be a plastic component that is glued to the measuring tube. Alternatively, the component can also be formed by a mechanical coupler which mechanically couples two measuring tubes to each other or a connecting body which is designed to connect the measuring tube module to a distributor piece and/or the process line. The component is attached to the measuring tube in such a way and the material of the component is preferably selected such that there is good heat transfer between the measuring tube and the component.

One embodiment provides that the component corresponds to the primary sensor component or the primary exciter component.

The primary sensor component or the primary exciter component can each be a permanent magnet, in particular in conjunction with a permanent magnet holder, which is connected, in particular in an integral manner, to the measuring tube.

The invention is explained in greater detail with reference to the following figures. In the drawings:

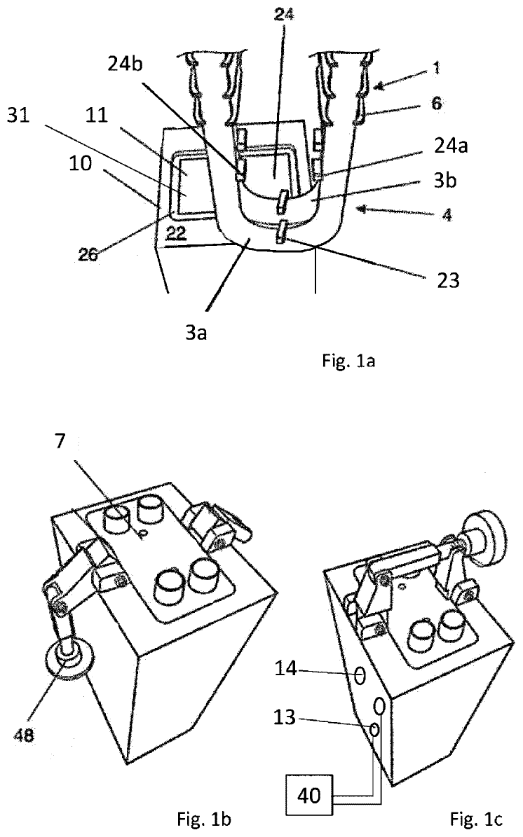

FIG. 1a: is a perspective view of an embodiment of the Coriolis flowmeter according to the invention, in which the measuring tube module is arranged next to the support module and its recess;

FIG. 1b: is a perspective view of an embodiment of the Coriolis flowmeter according to the invention, in which the measuring tube module is arranged in the recess;

FIG. 1c: is a perspective view of an embodiment of the Coriolis flowmeter according to the invention, in which the measuring tube module is fixed in the recess with a fastening device;

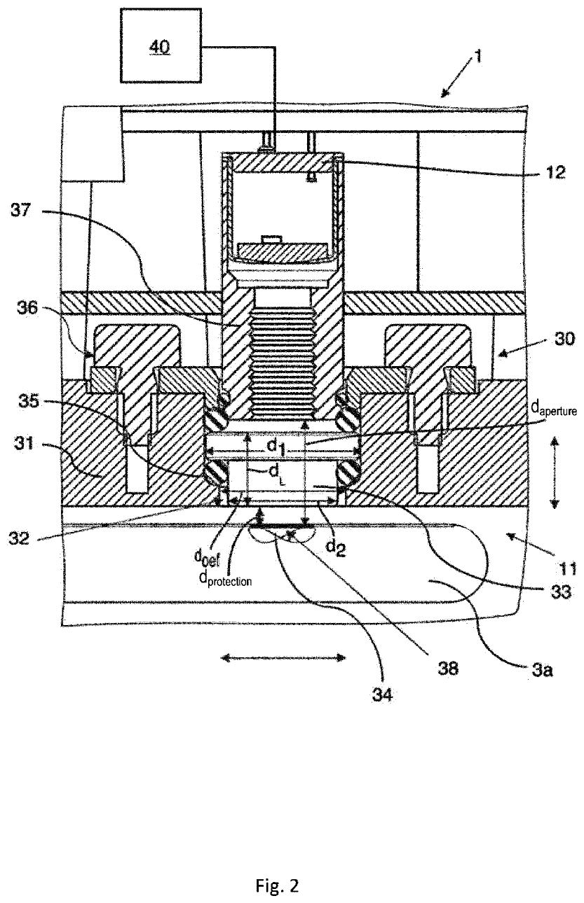

FIG. 2: is a detailed view of a longitudinal section through an embodiment of the Coriolis flowmeter according to the invention; and

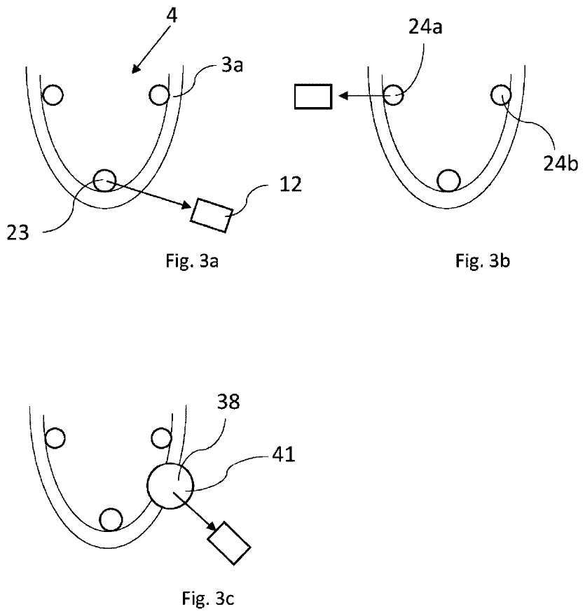

FIGS. 3a-c: show three embodiments of the modular Coriolis flowmeter according to the invention.

An embodiment according to the invention is shown in FIGS. 1a to 1c. These show the step-by-step assembly of the measuring tube module 4 in the recess 11 of the support module 10. FIG. 1a is a perspective view of an embodiment of the Coriolis flowmeter 1 according to the invention, in which the measuring tube module 4 is arranged next to the support module 10 and its recess 11. The modular Coriolis flowmeter 1 for determining a process variable of a flowable medium comprises a measuring tube module 4 and a support module 10. The measuring tube module 4 has at least one measuring tube 3 for guiding the flowable medium, the measuring tube 3 is preferably made of metal. However, it may additionally or alternatively comprise a plastic, a ceramic and/or a glass. In the illustrated embodiment, the measuring tube module 4 comprises exactly two measuring tubes 3a, 3b. A primary exciter component 23 is arranged on the outer lateral surface of each of the measuring tubes 3a, 3b. The primary exciter component 23 comprises at least one permanent magnet. Furthermore, two primary sensor components 24a, 24b are attached in each case to the outer lateral surfaces of the measuring tubes 3a, 3b. The primary sensor component 24a, 24b also comprises at least one permanent magnet. The respective inlet portions and the outlet portions of the two measuring tubes are connected to each other via a plate-shaped connecting body 7. This serves to fasten a distributor piece (not shown) to the measuring tubes 3a, 3b and has the contact surface for the fastening device 48. Alternatively, the distributor piece can also be connected to the measuring tubes 3a, 3b without a connecting body 7. In this case, the measuring tube module 4 is fastened with the fastening device 48 via the distributor piece. According to the illustrated embodiment, the mechanical connection of the support module 10 with the measuring tubes 3a, 3b is made via the connecting body 7. In the final assembled state, the connecting body 7 rests on a support surface 26 embedded in the support module body 22. Furthermore, mechanical couplers 6 are provided which connect the inlet portions or the outlet portions of the measuring tubes 3a, 3b to each other. The support module 10 comprises a recess 11 into which the measuring tube module 4 can be arranged with a detachable connection. The recess 11 is delimited by the support module wall 31 and, according to the embodiment shown, is essentially an opening in which or a free volume in the support module 10 in which the measuring tube module 4 can be arranged such that it can vibrate. The support module wall 31 is preferably made of metal. The measuring tube module 4 can be arranged in the recess 11 laterally, perpendicularly to its own longitudinal axis (not shown), or frontally in the direction of its own longitudinal axis. Separated from the recess 11 by the support module wall 31 is an electronics chamber 30 in which electronic components 40 for operating the modular Coriolis flowmeter 1 and for determining the process variable are arranged. The electronic components 40 may include connectors, cables, circuit boards, amplifiers, electronic circuits with resistors, capacitors, diodes, transistors and coils, digital and/or analog circuits, and/or a programmable microprocessor, i.e., a processor implemented as an integrated circuit. The electronic components 40 also include the operating circuit, control circuit, measuring circuit, evaluation circuit and/or display circuit.

FIG. 1b shows a measuring tube module 4 arranged in the recess 11. In this case, the connecting body 7 rests on the support surface 26. The measuring tubes 3a, 3b protrude into the recess 11 such that they can vibrate, without touching the support module wall 31 in the process. The connecting body 7 serves to form a connection with a connecting body (not shown), in particular a distributor piece, with which the measuring tube module 4 can be connected to a process line. The measuring tube module 4 shown is not fixed.

FIG. 1c shows a Coriolis flowmeter 1 in which the measuring tube module 4 is fixed in the recess 11 with a fastening device 48 in such a way that it can be released and replaced again by the operator. The measuring tube module 4 is mechanically detachably connected or connectable to the support module 10. After the measuring tube module 4 is fixed and thus properly arranged and set up, the secondary exciter component 13 and the secondary sensor component 14 are activated. In the arranged state of the measuring tube module 4, the secondary exciter component 13 and the primary exciter component 23, and correspondingly the secondary sensor component 14 and the primary sensor component 24a, 24b, interact magnetically. The secondary exciter component 13 is designed to cause the at least one measuring tube 3 to vibrate. For this purpose, the secondary exciter component 13 typically comprises a magnetic coil which is operated via an operating circuit. The operating circuit can be part of the electronic components 40. The coil generates a time-varying magnetic field depending on the operating signal with which it is operated. This causes a force on the primary exciter component 23, which causes the at least one measuring tube 3 to vibrate. The vibration behavior of the at least one measuring tube 3 is measured via the secondary sensor component 14. The temporally variable magnetic field of the primary sensor component 24a, 24b present locally at the secondary sensor component 14—which field results from the vibrations of the at least one measuring tube 3—generates an electrical measurement signal in the sensor component 14, which preferably also comprises a magnetic coil, which signal is used to determine the process variable. According to the illustrated embodiment, exactly two secondary exciter components 13 and four secondary sensor components 14 are provided. Alternatively, exactly one secondary exciter component 13 and exactly two secondary sensor 9 components 14 may also be sufficient for two measuring tubes 3a, 3b if these are arranged in the support module 10 in such a way that they are located between the two measuring tubes 3a, 3b, and thus also between the primary exciter components 23 and primary sensor components 24a, 24b in the arranged state. The secondary exciter component 13 and the secondary sensor component 14 are arranged in/on the support module 10. For example, they can be arranged such that they are separated from the recess 11 by the support module wall 31. Alternatively, the support module wall 31 can have exciter openings corresponding to the number of secondary exciter components 13, in which openings the secondary exciter components 13 are arranged. The same also applies to the secondary sensor component 14. The support module wall 31 can have sensor openings corresponding to the number of secondary sensor components 14, in which openings the secondary sensor components 14 are arranged.

FIG. 2 is a detailed view of a longitudinal section through an embodiment of the Coriolis flowmeter 1 according to the invention. The support module wall 31 separates the recess 11 from the electronics chamber 30. Electronic components 40 are arranged in the electronics chamber 30 and are electrically connected to the secondary exciter component and/or the secondary sensor component (not shown). A measuring tube 3a of a measuring tube module is arranged in the recess 11. The support module wall 31 has a through-opening 32 which connects the recess 11 with the electronics chamber 30. A protective glass 33 is arranged in this opening 32.

A contactless temperature sensor 12 is arranged in the electronics chamber 30 for determining a temperature of the measuring tube 3a or the medium guided in the measuring tube 3a. The temperature sensor 12 is oriented such that when the measuring tube module or the measuring tube 3a is arranged in the support module 10, in particular in the recess 11, it is directed onto a 33 surface of the measuring tube module 4—in the case shown onto a measuring tube surface 34 of the at least one measuring tube 3, in particular the measuring tube 3a—and receives a light beam emitted from the surface of the measuring tube module 4—in this case the measuring tube surface 34 of the at least one measuring tube 3—through the opening 32. Alternatively, the surface to be monitored can also be located on one of the mechanical couplers, the connecting body or the connection body or distributor piece. Alternatively, the measuring tube module 4 may further comprise a component which is attached to at least one of the measuring tubes 3a, 3b for the purpose of providing a sufficiently large radiating surface for determining the medium temperature (see FIG. 3c).

The temperature sensor 12 has an, in particular anodized, aperture 37 for blocking interference radiation, a lens and an SMD IR sensor. In this case, the aperture 37 is as far as possible designed as a black radiator (e.g., made of anodized aluminum) so that it does not itself emit any radiation onto the SMD IR sensor. In the embodiment shown, the temperature sensor 12 is arranged on a circuit board. The aperture 37 has a minimum distance d_{aperture,min} to the measuring tube surface 34 of 1 mm, in particular of 2 mm and preferably of 4 mm. In addition, the aperture 37 has a maximum distance d_{aperture,max} to the measuring tube surface 34 of 18 mm, in particular of 12 mm and preferably of 9 mm.

The protective glass 33 comprises zinc sulfide and/or chalcogenides at least in portions. The protective glass is shaped, constructed and arranged in the opening in such a way that cleaning agent does not penetrate into the electronics chamber 40 when cleaning the support module 10. For this purpose, the protective glass 33 has a first diameter d₁ in a first portion and a second diameter d₂ in a second portion. In this case, the first diameter d₁ is larger than the second diameter d₂ and the first diameter rd₁ is larger than a smallest diameter d_{oef} of the opening 32. The protective glass 33 has a maximum extension d_{L,max} in the longitudinal direction of a maximum of 15 mm, in particular 10 mm and preferably 7 mm, and a minimum extension d_{L,min} of at least 0.5 mm, in particular 1 mm and preferably 3 mm. The recess 11 and the measuring tube module 4 are designed in such a way that a distance d_{protection} between the measuring tube surface 34 and protective glass 33 is smaller than 5 and larger than 0.5 mm, in particular smaller than 3 and larger than 0.7 mm and preferably smaller than 2 and larger than 1 mm. The dimensions are selected such that as little ambient radiation as possible penetrates through the opening into the temperature sensor 12 and that, if possible, only the radiation emitted by the measuring tube 3a is recorded by the temperature sensor 12.

In the second portion of the protective glass 33, a sealing means 35 for sealing the recess 11 relative to the recess 11—in the case shown, a sealing ring-is arranged on the protective glass 33, in particular in such a way that it is openly visible from the recess 11. This means that the requirement to ensure the product quality of medicinal products and active ingredients in accordance with current Good Manufacturing Practice (cGMP) and IP56, which will come into force in 2022, is met.

The support module 10 has a fastening device 36 for fixing the protective glass 33 in the opening 32. The fastening device is arranged in the electronics chamber 30 and is designed or configured to press the protective glass 33 from the interior of the electronics chamber 30 in the direction of the recess 11. The protective glass 33, in particular the first portion of the protective glass 33, is pressed against the sealing means 35. In the embodiment shown, the fastening device 36 comprises an annular disk which is connected to the support module wall 31 via screws. The aperture 37 extends through a central opening in the annular disk. The annular disk is in contact and interacts with a sealing ring which is arranged on a surface of the protective glass 33 facing the interior of the electronics chamber 30. Alternatively, the annular disk can be in direct contact with the protective glass 33. The annular disk has a collar which faces the protective glass 33 and which extends around the central opening of the annular disk. In the embodiment shown, the annular disk is rotationally symmetrical.

Individual components of the electronic components 40 are also electrically connected to the temperature sensor 12—which can be designed as an infrared sensor. The infrared sensor is designed to detect infrared light and, depending on this, to determine a temperature of the measuring tube 3a or a measured value correlating with the temperature of the measuring tube 3a. The temperature of the measuring tube 3a can be determined via the evaluation circuit. The temperature sensor 12 is suitable for determining the temperature of the measuring tube 3a in a contactless manner, i.e., without being in direct mechanical contact with the measuring tube 3a. This is also arranged in the electronics chamber 30 and separated from the measuring tube 3a by a protective glass 33. In order to be able to determine a temperature of the measuring tube 3a, the temperature sensor 12 is oriented such that when the measuring tube module is arranged in the support module, in particular in the recess 11, the temperature sensor 12 is directed onto a measuring tube surface 34 of the at least one measuring tube 3 and receives a light beam emitted from the measuring tube surface 34 of the measuring tube 3 through the opening 32.

The recess 11 and the measuring tube module 4 are designed such that the recess 11 or the internal volume in which the at least one measuring tube is located is sealed off in a substantially light-tight manner when the measuring tube module 4 is arranged.

The at least one measuring tube 3 or the illustrated measuring tube 3a has a temperature measuring point 38 in the form of a matting. The surface structuring of the temperature measuring point 38 differs from the structuring on the remaining measuring tube surface. The temperature sensor 12 is oriented such that it is directed towards the temperature measuring point 38. The temperature measuring point 38 can be structured by means of a laser process and/or a surface treatment by the action of blasting media, in particular sand. Alternatively, the temperature measuring point 38 can be formed by a film applied to the at least one measuring tube or the measuring tube 3a, which film can also have a structuring.

In the illustrated embodiment, the temperature sensor is directed at the measuring tube which vibrates during operation. Alternatively, the temperature sensor can also be oriented such that it is directed towards one of the mechanical couplers, towards a non-vibrating portion of the measuring tube, the connecting body 7 or the connection body or the distributor piece of the measuring tube module.

FIGS. 3a to 3c show a plurality of different embodiments of the measuring tube module 4, in which the temperature sensor 12 is directed at different surfaces of the measuring tube module 4 or determines the medium temperature based on different radiating surfaces of the measuring tube module 4. In the embodiment of FIG. 3a, the contactless temperature sensor 12 is oriented such that it is directed towards the surface of the primary exciter component 23—in this case, the primary exciter component 23 is a permanent magnet attached to the measuring tube 3a—and receives a light beam emitted from the surface (see arrow).

In the embodiment of FIG. 3b, the contactless temperature sensor 12 is oriented such that it is directed towards the surface of the primary sensor component 24a—in this case the primary sensor component 24a is a permanent magnet attached to the measuring tube 3a—and receives a light beam emitted from the surface (see arrow).

In the embodiment of FIG. 3c, the contactless temperature sensor 12 is oriented such that it is 28 directed towards a surface of a component 41 attached to the measuring tube 3a—in this case, the attached component 41 is a black plastic component—and receives a light beam emitted by the surface (see arrow). The component 41 is designed such that a measurement signal resulting from the light emitted by the component 41 and received by the temperature sensor 12 is greater than a measurement signal that would result if the temperature sensor 12 were directed at a measuring tube surface of the measuring tube 3a. For this purpose, the component 41 has, for example, a cross-sectional area that is larger than a partial portion surface area of the measuring tube 3a that would contribute to the measurement signal at the temperature sensor 12.

### LIST OF REFERENCE SIGNS

Modular Coriolis flowmeter 1
Measuring tube 3a, 3b
Measuring tube module 4
Coupler 6
Connecting body 7
Support module 10
Recess 11
Temperature sensor 12
Support module body 22
Secondary exciter component 13
Secondary sensor component 14
Primary exciter component 23
Primary sensor component 24a, 24b
Support surface 26
Electronics chamber 30
Support module wall 31
Opening 32
Protective glass 33
Measuring tube surface 34
Sealing means 35
Fastening device 36 for fixing the protective glass
Aperture 37
Temperature measuring point 38
Electronics component 40
Component 41
Fastening device 48 for fixing the measuring tube module

1-17. (canceled)

18. A modular Coriolis flowmeter for determining a process variable of a flowable medium, the modular flowmeter comprising:
a measuring tube module, comprising:
at least one measuring tube configured to convey the medium;
a primary exciter component arranged on the at least one measuring tube; and
a primary sensor component arranged on the at least one measuring tube; and
a support module, comprising:
a receptacle in which the measuring tube module can be introduced via a detachable connection;
an electronics chamber in which electronics components configured to operate the modular Coriolis flowmeter are disposed; and
a support module wall configured to define the electronics chamber and the receptacle, wherein the support module wall includes a through-opening which connects the receptacle to the electronics chamber, wherein a protective glass is disposed in the opening;
a contactless temperature sensor disposed in the electronics chamber and orientated such that, when the measuring tube module is introduced in the receptacle, the temperature sensor is directed towards a surface of the measuring tube module and is arranged to receive radiation from the surface of the measuring tube module through the opening;
a secondary exciter component that is complementary to the primary exciter component; and
a secondary sensor component that is complementary to the primary sensor component.

19. The modular flowmeter according to claim 18, wherein the temperature sensor is an infrared sensor, and the radiation comprises infrared light.

20. The modular flowmeter according to claim 18, wherein the protective glass is composed of zinc sulfide at least in portions.

21. The modular flowmeter according to claim 18, wherein the protective glass includes chalcogenides at least in portions.

22. The modular flowmeter according to claim 18, wherein the protective glass has a first diameter at a first portion and a second diameter at a second portion,
wherein the first diameter is larger than the second diameter, and
wherein the first diameter is larger than a smallest diameter of the opening.

23. The modular flowmeter according to claim 22, wherein in the second portion of the protective glass a seal is arranged on the protective glass, wherein the seal is adapted to seal the electronics chamber relative to the receptacle.

24. The modular flowmeter according to claim 18, wherein the protective glass has a length in the longitudinal direction of no more than 15 mm, wherein the length is at least 0.5 mm.

25. The modular flowmeter according to claim 18, wherein the support module includes a fastener adapted to fix the protective glass in the opening such that the fastener presses the protective glass from an interior of the electronics chamber toward the receptacle.

26. The modular flowmeter according to claim 18, wherein:
the temperature sensor includes an anodized aperture configured to block interference radiation;
the aperture is a minimum distance to the measuring tube module surface of 1 mm; and
the aperture is a maximum distance to the measuring tube module surface of 18 mm.

27. The modular flowmeter according to claim 18, wherein the at least one measuring tube includes a temperature measuring point in the form of a matting, which includes a structuring that differs from a remaining surface of the at least one measuring tube, and
wherein the temperature sensor is directed toward and is arranged to receive radiation from the temperature measuring point.

28. The modular flowmeter according to claim 27, wherein the temperature measuring point is structured by a laser process.

29. The modular flowmeter according to claim 27, wherein the temperature measuring point is structured by a surface treatment using a blasting media.

30. The modular flowmeter according to claim 27, wherein the temperature measuring point is formed by a film, which includes the structuring, applied to the at least one measuring tube.

31. The modular flowmeter according to claim 18, wherein the receptacle is essentially light-tight when the measuring tube module is introduced therein.

32. The modular flowmeter according to claim 18, wherein a gap distance between the measuring tube module surface and the protective glass is less than 5 mm and greater than 0.5 mm.

33. The modular flowmeter according to claim 18, wherein the measuring tube module includes a temperature measuring point, which is configured as a component attached to the at least one measuring tube in a form-fitting and/or integral manner,
wherein the temperature sensor is directed toward and is arranged to receive radiation from the temperature measuring point.

34. The modular flowmeter according to claim 33, wherein the component corresponds to the primary sensor component and/or the primary exciter component.

35. The modular flowmeter according to claim 18, wherein the surface of the measuring tube module is a surface of the least one measuring tube.

36. The modular flowmeter according to claim 24, wherein the length of the protective glass is no more than 7 mm and at least 3 mm.

37. The modular flowmeter according to claim 26, wherein the minimum distance is 4 mm, and the maximum distance is 9 mm.

38. The modular flowmeter according to claim 32, wherein the gap distance is less than 2 and greater than 1 mm.
